(19) United States
(12) Patent Application Publication
(10) Pub. No.: US 2019/0272157 A1
(43) Pub. Date: Sep. 5, 2019

(54) SYSTEM AND METHOD FOR EMBEDDING DOMAIN-SPECIFIC LANGUAGE CODE WITHIN A VISUALIZATION OF CLOUD-BASED COMPUTING INFRASTRUCTURE

(71) Applicant: FUGUE, INC., Frederick, MD (US)

(72) Inventor: Josha STELLA, Shepherdstown, WV (US)

(73) Assignee: FUGUE, INC., Frederick, MD (US)

(21) Appl. No.: 16/290,516

(22) Filed: Mar. 1, 2019

Related U.S. Application Data
(60) Provisional application No. 62/637,160, filed on Mar. 1, 2018.

(51) Int. Cl. G06F 8/34; G06F 8/41; G06F 8/70; G06F 16/838; G06F 17/22; G06F 9/455

(52) U.S. Cl. CPC G06F 8/34; G06F 8/41; G06F 8/70; G06F 2009/45595; G06F 17/2247; G06F 9/45558; G06F 16/838

(57) ABSTRACT

A system and method for generating a visualization of cloud based computing system based on a domain-specific language file is provided. In one or more examples, the domain-specific language file is compiled so as to generate a data file. The data file is parsed to generate an intermediate file that converts the computing resources found in the data file into symbolic representations. The intermediate file is then processed so as to produce a position for each symbol within the symbolic representation. Finally, the symbolic representation is rendered using a markup language such as HTML.

### CROSS-REFERENCE TO RELATED APPLICATION

This application claims the benefit of U.S. Provisional Application No. 62/637,160 filed Mar. 1, 2018, the entire contents of which are incorporated herein by reference.

### FIELD OF THE DISCLOSURE

The invention relates to a system and method for embedding domain-specific language code within a visualization of cloud-based computing infrastructure.

### BACKGROUND OF THE INVENTION

A number of cloud service providers sell various cloud services to execute compute instances on behalf of their customers. For example, AMAZON sells its AMAZON WEB SERVICES (AWS) service, GOOGLE sells its GOOGLE APP ENGINE service, and others sell similar services. In exchange for a fee, AMAZON, GOOGLE, and other cloud service providers provide the use of their servers and other infrastructure to customers for a limited time in the form of a cloud service instance. The fee may vary depending on a time/date that the cloud service instance is to be run, a performance of the cloud service instance (e.g., throughput, latency, etc.), whether the offered cloud service instance is a spot instance or a standard instance, and/or other attributes.

Integrating use of cloud services into an organization's processes can be difficult. Conventionally, users can manually enter an input into a cloud services command line interface (CLI) or graphical user interface (GUI). Making the process of creating cloud infrastructure more user friendly can be achieved through the use of specialized programs in conventional programming languages that attempt to instantiate, monitor, and update cloud instances. However, the use of conventional programming languages to create computing infrastructure in a cloud environment can prove to be cumbersome and complex.

Providing a user with a domain-specific programming language, in which the programming language can be configured to allow the user to easily declare the desired infrastructure, can aid in decreasing the burden associated with using a programming language to build computing infrastructure on a cloud. To further aid the user in developing computing infrastructure using the domain-specific programming language described above, a visualization tool that allows for the user to visualize the computing infrastructure they are building using the domain-specific programming language could facilitate the coding process. Furthermore, allowing a user to simultaneously share their code and the generated visualization with other users by embedding the code within the visualization can make sharing code less cumbersome and more convenient.

### SUMMARY OF THE DISCLOSURE

Accordingly, the following disclosure is related to a domain specific language for cloud services infrastructure which allows for a user to create a computing environment using a user-friendly syntax that can be converted into code that is readable by a cloud computing services provider and a method for generating a visualization of the computing environment and embedding the user-generated code within the visualization.

In one example, a visualization of the computing infrastructure, that if implemented would be built by the code, can be generated. The visualization can use the domain-specific programming to generate a visualization of the computing infrastructure to be built by the code, and can also provide one or more visual interfaces that allows a user to determine if there are any errors contained within the code, or whether the code violates an organization's computing policies as determined by a validation process (described in detail below).

In another example, the visualization can be generated using an image format file type. The user-generated code can be embedded into the image format file in a manner so as to not interfere with the visualization of the computing system. The image can be transmitted to another user or third party. The receiver of the image can extract the source code by utilizing a program that is configured to parse the image format file in a manner so as to extract out the user-generate code embedded within the image format file.

### BRIEF DESCRIPTION OF THE DRAWINGS

FIG. 1 illustrates a system of providing and executing a domain-specific programming language for cloud services infrastructure, according to an implementation of the invention.

FIG. 2 illustrates a process flow diagram of various system components for providing and executing a domain-specific programming language for cloud services infrastructure, according to examples of the disclosure.

FIG. 3 illustrates an exemplary runtime environment of a compiled domain specific programming language for cloud services infrastructure, according to examples of the disclosure.

FIG. 4 illustrates a process of compiling a domain-specific programming language for cloud services infrastructure, according to examples of the disclosure.

FIG. 5 illustrates an exemplary explain process according to examples of the disclosure.

FIG. 6 illustrates a process of executing a domain-specific programming language for cloud services infrastructure, according to examples of the disclosure.

FIG. 7 illustrates an exemplary visualization of computing infrastructure created by domain-specific programming language code according to examples of the disclosure.

FIG. 8 illustrates an exemplary method for generating a visualization of computing infrastructure using domain-specific programming language code according to examples of the disclosure.

FIG. 9 illustrates another exemplary method for generating a visualization of computing infrastructure using domain-specific programming language code according to examples of the disclosure.

FIG. 10 illustrates an exemplary compilation error message generated by a visualization tool according to examples of the disclosure.

FIG. 11 illustrates an exemplary visualization of computing infrastructure using domain-specific programming language code that includes visualizations associated with validation errors according to examples of the disclosure.

FIG. 12 illustrates an exemplary instance inspection in a visualization of domain-specific programming language code according to examples of the disclosure.

FIG. 13 illustrates an exemplary method for embedding a domain-specific language code file within an image file associated with a visualization of a computing system according to examples of the disclosure.

FIG. 14 illustrates an exemplary method for extracting a domain-specific language code file from an image file associated with a visualization of a computing system according to examples of the disclosure.

FIG. 15 illustrates an example of a computing device in according to examples of the disclosure.

### DETAILED DESCRIPTION OF THE INVENTION

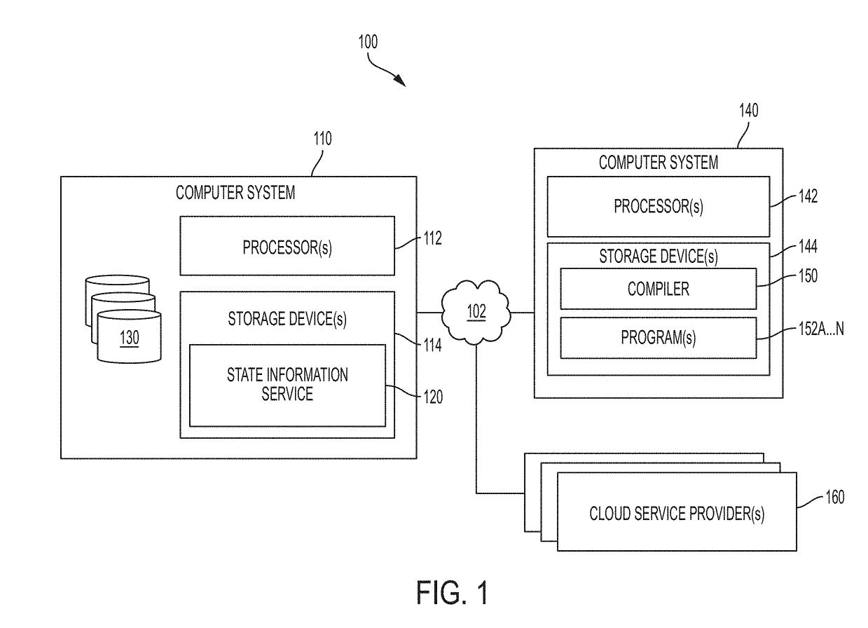

FIG. 1 illustrates a system 100 of providing and executing a domain-specific programming language for cloud services infrastructure (hereinafter, “domain-specific programming language” for convenience), according to an implementation of the invention. The system may be used to integrate references to external entities, such as cloud service compute instances, directly into a domain-specific programming language, allowing developers to easily integrate cloud services directly using the domain-specific programming language.

For illustration and not limitation, the external entities will be described as cloud compute instances (e.g., compute instances executed at a computer operated by a cloud service provider) that may be referenced directly within the domain-specific programming language described herein. However, other external entities (e.g., external to a given memory of a computer device that executes code that uses the domain-specific programming language described herein) may be used as well. As an example, the external entities can include DNS entries, binary objects, shared queues, database tables, etc.

The system may be used to facilitate checking against the type and state of an external entity in the language itself, including at authoring, build and run times. Furthermore, the system may facilitate compilation, type checking and debugging while authoring programs against external entities as opposed to requiring testing to be performed to find errors and bugs.

Language primitives that are references to infrastructure or other external entities

Typically, in a programming language, a variable may be resolved to an address in memory at runtime. For example, if one were to define my-thing=123456, this would put the value 123456 to a location in memory. After definition, any code using my-thing would either get a reference to that memory address or would receive a copy of the value.

Using the domain-specific programming language described herein, references to external entities (not in memory) as variables may be used. For example, by defining mything=this-instance, this-instance would be resolved to a URL or other identifier of a running virtual computer, as opposed to an address in memory. This allows for checking against the type and state of an external entity in the language itself, including at authoring, build and run times. The reference may be set by another program, manual configuration (e.g., at compile time), and/or other processes. By using language primitives that are references to cloud services infrastructure, the system facilitates checking, at compile and debug time, for the legitimacy of the reference, and to have a valid reference at runtime. Computing infrastructure can refer to components within a computing system that are being provided by a cloud service rather than having to use physical on-site devices. For instance computing infrastructure can refer to computing devices such as virtual machines, load balancers, virtual networks, data storage services, domain name services, disk imagers, containers, clusters, and lambda instructions. These examples are not meant to be limiting, and are only provided as examples. The domain-specific programming language further facilitates compilation, type checking and debugging while authoring programs against external entities as opposed to requiring testing to be performed to find errors and bugs.

Lexical Scoping that Maps to Abstractions of External Entities

In typical programming languages, lexical scoping is a way to organize pieces of code such that names can be re-used and also to allow for segmentation and encapsulation of elements of the program. For example, a private field in an Object-Oriented language prevents direct access to that data from outside the instance of the Class in which it is defined.

Using the domain-specific programming language described herein, lexical scoping may be mapped onto collections of entities that aren't a native part of the language. For example, a compute instance may be defined using the reference to external entity method described above: my-thing=this-instance, where this instance is a pointer to an actual entity in the runtime environment.

Using external entity lexical scoping, the system may make this-instance a child of this venue, where this-venue may include an arbitrary collection of entities. If this-instance was not public to the scope of the calling code, the compiler would return an error when directly referencing. This may occur when, for example, the scope of a variable was limited to a particular set of entities. The external entity may be associated with a single cloud service provider or different cloud service providers, the identification of which may be associated with a given variable or reference.

Externalizing the language runtime state information to a service

In order to facilitate these and other benefits, the system may maintain state information of all references and shared variables across program boundaries. The system may make the state information accessible via a state information service that understands the language features of the domain-specific programming language.

At compile time, the compiled code can be processed by an interpreter module of the run-time environment (explained in detail below) that may query the state information service to identify a variable in scope to the use in the language in order to determine if it exists, and, if so, whether it is in scope to reference. The state information service may also deliver details on how the entity may be used, such as available functions or operations.

The state information service may keep detailed version information on the state of the variable. For example, if user A creates an entity via compiling and running a program, a corresponding variable may appear in the state information service, along with a serial number (or other version information) set to 1. In some examples, the corresponding variable can be a unique hash derived from the computing infrastructure's instance in the program. During the normal operations of the entity, its state changes (e.g., to another Internet Protocol address). A second program that initiates the change may update the table with the new IP address, and may increment the serial number to 2. When a third program references the entity, and has a version 1 understanding of the state, it sees that the new serial number is 2 and may query the state information service for the latest version.

The state information may be made generic and scoped across all the entities the organization wishes to have available. In this way, multiple users across many parts of an organization may interoperate with the products of their peers in other teams dynamically.

Other uses of system 100 are described herein and still others will be apparent to those having skill in the art. Having described a high level overview of some of the system functions, attention will now be turned to various system components that facilitate these and other functions.

The above infrastructure primitives and the lexical scoping applied to them, as discussed above, can be used to create functions that can yield patterns of infrastructure based on certain arguments inputted into those functions. The code example provided below, is an example of an enumeration type:

Type IcmpDescription:

| Ping
| DestinationUnreachable
| RedirectMessage

The code example provided below, is an example of a data structure type that can define the properties of an “icmp.” In the example below, the icmp type has the property values “type” and “code” and these properties are expressed as integers.

Type Icmp:

| type: INT
| code: INT

The code example below, illustrates an example function using the domain specific language. The example code below taken a infrastructure description and evaluates to an icmp (machine data).

Icmp fromDescription(IcmpDescription icmp):

Case icmp of

| | |
|---|---|
| \| ping | {code: 0, type: 0} |
| \| DestinationUnreachable | {code: 0, type: 3} |
| \| Redirect Message | {code: 0, type: 5} |

The above functions can be evaluated at compile time by the explain function described in further detail below.

### Exemplary System Architecture

System 100 may include a computer system 110, a computer system 140, one or more cloud service providers 150, and/or other components.

### Computer System 110

Computer system 110 may include one or more processors 112 (also interchangeably referred to herein as processors 112, processor(s) 112, or processor 112 for convenience), one or more storage devices 114 (which may store a state information service 120, hereinafter SIS 120 for convenience), one or more entity state information databases 130, and/or other components. Processors 112 may be programmed by one or more computer program instructions. For example, processors 112 may be programmed by SIS 120 and/or other instructions.

### Computer System 140

Computer system(s) 140 may each include one or more processors 142 (also interchangeably referred to herein as processors 142, processor(s) 142, or processor 142 for convenience), one or more storage devices 144 (which may store a compiler 150A, one or more programs 152, and/or other instructions), and/or other components. Processors 142 may be programmed by one or more computer program instructions. For example, processors 142 may be programmed by compiler 150, programs 152, and/or other instructions.

### Cloud Service Providers 160

Cloud service providers 160 may include entities that sell various cloud services to execute compute instances on behalf of their customers. For example, AMAZON sells cloud service instances using its AMAZON WEB SERVICES (AWS) service, and GOOGLE sells cloud service instances using its GOOGLE APP ENGINE service. In other examples, cloud service providers can also include other specialized providers who provide non-compute services such as content delivery networks, domain name service, etc.

Cloud service providers 160 may also include entities that provide markets, or exchanges, for cloud services. For example, cloud service providers 160 may include markets that sell cloud service instances on behalf of others that actually provide the cloud service instances using their infrastructure. In this manner, system 100 may leverage exchanges that may sell various cloud service instances from different entities.

Although illustrated in FIG. 1 as a single component, computer system 110 and computer system 140 may each include a plurality of individual components (e.g., computer devices) each programmed with at least some of the functions described herein. In this manner, some components of computer system 110 and/or customer computer system 140 may perform some functions while other components may perform other functions, as would be appreciated. The one or more processors 112, 142 may each include one or more physical processors that are programmed by computer program instructions. The various instructions described herein are exemplary only. Other configurations and numbers of instructions may be used, so long as the processor(s) 112, 142 are programmed to perform the functions described herein.

Furthermore, it should be appreciated that although the various instructions are illustrated in FIG. 1 as being co-located within a single processing unit, in implementations in which processor(s) 112, 142 includes multiple processing units, one or more instructions may be executed remotely from the other instructions. In addition, at least some of the functions described herein with respect to processor(s) 112 may be performed by processor(s) 142, and vice versa. For example, processor(s) 112 may be programmed by compiler 150, programs 152, and/or execute a runtime environment for programs 152. Likewise, processor(s) 142 may be programmed with state information service 120.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the instructions.

The various instructions described herein may be stored in a storage device 114, which may comprise random access memory (RAM), read only memory (ROM), and/or other memory. The storage device may store the computer program instructions (e.g., the aforementioned instructions) to be executed by processor 112 as well as data that may be manipulated by processor 112. The storage device may comprise floppy disks, hard disks, optical disks, tapes, or other storage media for storing computer-executable instructions and/or data.

The various components illustrated in FIG. 1 may be coupled to at least one other component via a network 102, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1 and other drawing Figures, different numbers of entities than depicted may be used. Furthermore, according to various implementations, the components described herein may be implemented in hardware and/or software that configure hardware.

The entity state information database 130 (and/or any other database) described herein may be, include, or interface to, for example, an Oracle™ relational database sold commercially by Oracle Corporation. The example database provided above is not meant to be limiting and the entity state information database 130 could include, or be interfaced to other databases, such as Informix™, DB2 (Database 2), Amazon DynamoDB™ or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

### Exemplary System Processing Operations

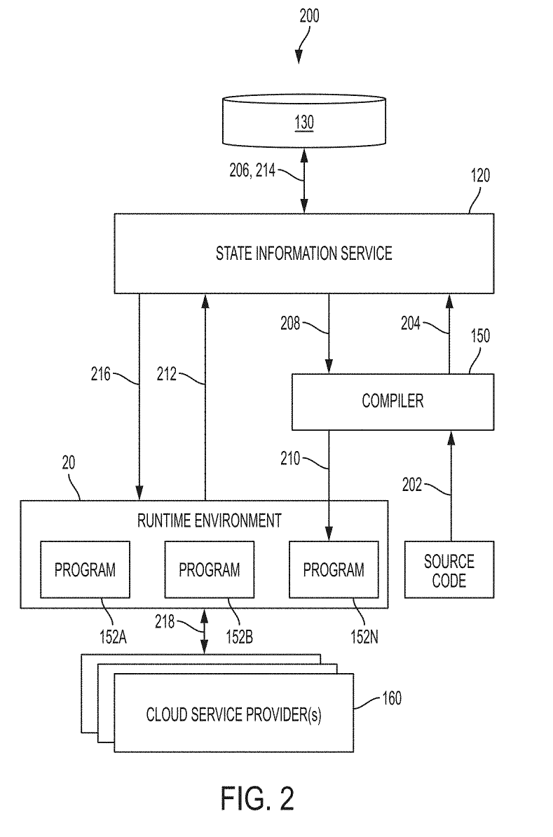

FIG. 2 depicts a process flow diagram 200 of various system components for providing and executing a domain-specific programming language for cloud services infrastructure, according to an implementation of the invention. The various processing operations and/or data flows depicted in FIG. 2 are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 202, source code in the domain-specific programming language for cloud services infrastructure may be received. For example, a developer may draft the source code to be received and compiled by compiler 150.

The compiled code generated by compiler 150 may be sent to the run-time environment 20, in which an explain action can be initiated (described further below) and a query can be sent to SIS 120 to identify a variable in scope to the use in the source code to determine whether the variable exists, and, if so, whether the variable is in scope to the reference.

In an operation 206, SIS 120 may query entity state information database 130 to obtain the state information for the variable and/or the reference.

SIS 120 may obtain and provide any relevant state information (which may indicate an existence of the variable, its scope, a reference to an external entity such as a compute instance provided by cloud service provider 150, how an entity may be used such as its available functions, etc.) to the other components in the run-time environment (or return NULL or other indication that the variable does not exist).

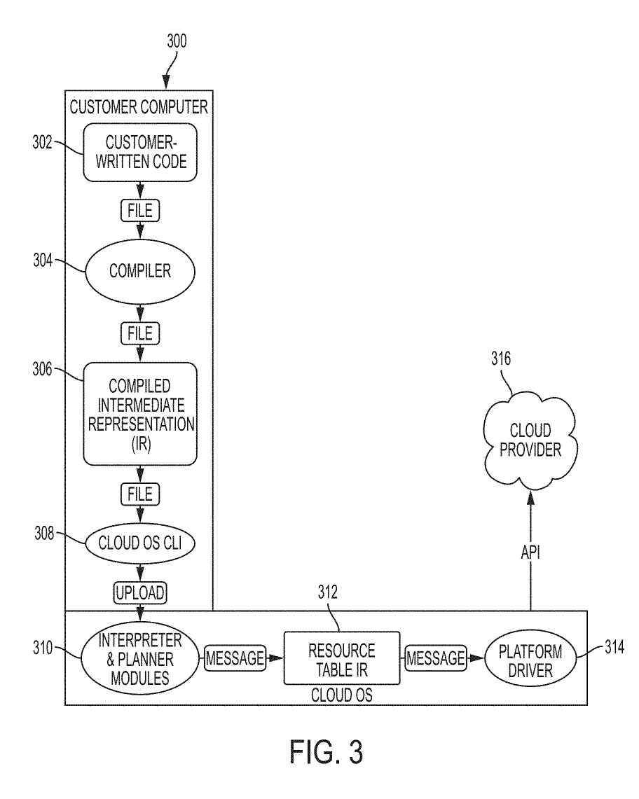

In an operation 210, compiler 150 may generate an executable program (hereinafter referred to as program 152A for convenience) if the variable exists and is in scope based on the state information. Program 152A may be placed run in runtime environment 20, along with other programs (152B, . . . , N) that have been compiled by compiler 150. The run-time environment is discussed in detail below with respect to FIG. 3.

In an operation 212, runtime environment 20 may execute program 152B. For example, program 152B may be called to run in runtime environment 20 by a human user, a process, and/or other user. Runtime environment 20 may query SIS 120 to identify a variable in scope to the use in the program 152B to determine whether the variable exists, and, if so, whether the variable is in scope to the reference. For example, runtime environment 20 may transmit the query via network 102 to SIS 120.

In an operation 214, SIS 120 may query entity state information database 130, as described with respect to operation 206.

In an operation 216, SIS 120 may obtain and provide any relevant state information to runtime environment 20, as described before with respect to operation 208. Runtime environment may cause an error (e.g., a runtime fault) to occur if a given variable is not in scope to the calling compiled code (program 152B). Otherwise, runtime environment 20 may obtain a current state of a given variable in program 152B at the time of execution so that any state changes related to a referenced entity (e.g., compute instance executing at a cloud service provider 160) may be accounted for during execution of program 152B.

In an exemplary operation of programs in runtime environment 20, a user may compile and execute program 152A, which may include a variable that references an entity and causes the entity to be created. For example, the created entity may include, without limitation, a compute instance at cloud service provider 160. In other words, using the domain-specific language described herein, instantiation of a variable may refer to, and cause to be created, a corresponding compute instance. In an implementation, the source code for program 152A may specify/define the cloud instance to which the variable is referenced or the cloud instance may be defined by a configurable parameter setting. Upon compilation, SIS 120 may store the variable, its reference, its state, how the compute instance may be used, and/or other state information using entity state information database 130.

Program 152B may also include the variable. When program 152B is compiled, an explain action can be executed in the run-time environment (explained in further detail below) that may query SIS 120 to determine whether the variable is in-scope to program 152B. Likewise, when program 152B is run, runtime environment 20 may query SIS 120 to determine whether the variable is in-scope as well as obtain current state information related to the variable.

In some instances, program 152B may cause the variable to be updated. For example, program 152B may cause a replacement compute instance to replace the existing compute instance at cloud service provider 160, causing an addressable identifier (e.g., an Internet Protocol address) to be changed to refer to the replacement computer instance. Responsive to such change, runtime environment 20 may provide SIS 120 with the update, which may update entity state information database 130 with the updated information for the variable. In another example, changes to instances of computing infrastructure (i.e., variables) initiated by an external actor (such as a user manually operating the cloud computing environment interface can be reverted back to its original form, it is found that the altered form does not conform to the original instance of the computing instance specified by the user through the domain specific programming language.

Program 152N may also include the variable. Variables from program 152N may be validated at compile and runtime, as described above. Program 152N, when executed, may obtain the current state information related to the variable. For instance, instead of a reference to a compute instance created by program 152A (which may have cause the compute instance to be created), a variable included in program 152N may reference the current compute instance, as updated by program 152B. In this manner, different programs may update the same variable, which may cause references for those variables to be updated as well. Using the domain-specific language described herein, different developers may therefore refer to different entities (such as compute instances at cloud service providers 160) natively within the language of the code.

FIG. 3 illustrates an exemplary run-time environment of a compiled domain-specific programming language for cloud services infrastructure, according to examples of the disclosure. As illustrated in FIG. 3, at the customer/client computer 300, a user can compose computer code using a domain-specific programming language that specifies computing infrastructure to implement on a cloud-based computing service.

Once a user has generated the code, the code is compiled at step 304, wherein it is converted from a user-friendly syntax generated by the user into an intermediate representation (illustrated at step 306) that can be understood by the command line interface of an infrastructure operating system. At step 308, the infrastructure operating system can execute the compiled code 306 by building and tracking what the code declares.

The code can then be sent to the interpreter and planner modules 310 that convert the command line interface language (i.e., intermediate representation 306) into a series of specific instructions that can executed by the infrastructure operating system. In one example the interpreter manager can use one or more planning modules to build the instructions. The interpreter manager can achieve this by employing a series of planning modules that accept, in some examples, resource tables at its input and generates resource tables in which any omissions in the syntax provided by the user are filled in. In one example, the planning modules can receive a resource table that specifies properties of the computing infrastructure to be built. The interpreter manager can review a resource table sent by the user (in the form of compiled domain specific code and send it to the series of planning modules based on what infrastructure needs have been declared by the user.

The planning modules alter the user's resource table and return it to the interpreter manager. This process may be repeated with other planning modules until the final correct version of the resource table is complete at step 312. The interpreter manager then converts the resource table into a machine instruction file which can be referred to as a low level declaration of the computer infrastructure to be built on the cloud. The low level declaration is then sent to the builder/driver 314 wherein the resource table is converted into a language that can be interfaced with the application program interface of a cloud provider 316.

As part of its operation, the interpreter and planner modules 310 can input the user declared instances of computing infrastructure, as well as the scope of those declared instances, generated by the user in the domain specific computing language. The interpreter can query an external state information service database (discussed above) to determine if the type of computing instance declared by the user exists, and if so, the state information service can provide any relevant state information to the interpreter.

Once the computing infrastructure has been built on the cloud computing environment, the implemented infrastructure can be “persisted” which means that the implemented infrastructure can be compared against the user's originally declared instance of the computing infrastructure as expressed in the domain-specific programming language. If any differences are found, the implementation of the computing infrastructure can be modified by the interpreter 310, so that the implementation of the infrastructure on the cloud matches the user's desired infrastructure.

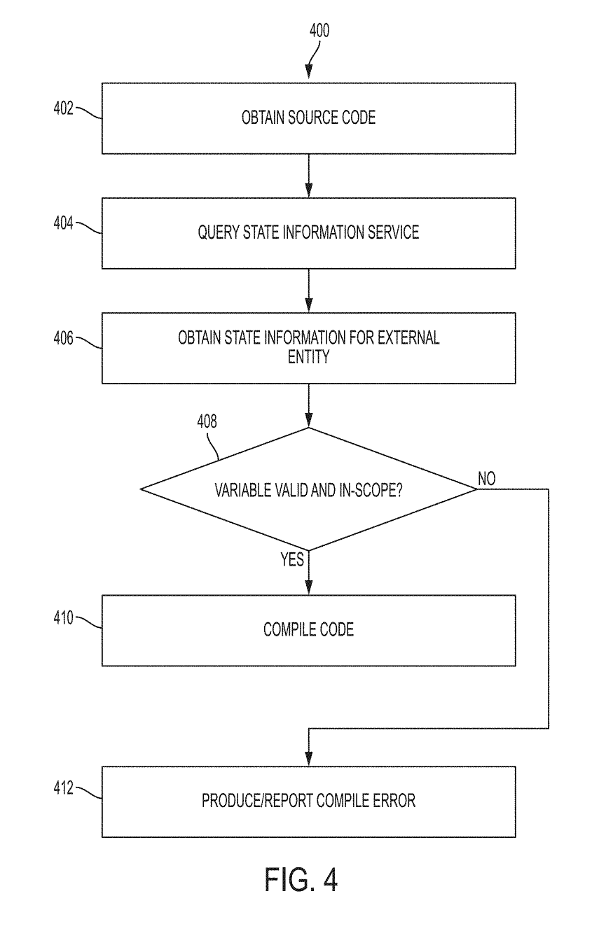

FIG. 4 illustrates a process 400 of compiling a domain-specific programming language for cloud services infrastructure, according to an implementation of the invention. The various processing operations and/or data flows depicted in FIG. 4 are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 402, source code in a domain-specific programming language may be obtained.

In an operation 404, a state information service may be queried to identify a variable in scope to the use in the language in order to determine if it exists, and, if so, whether it is in scope to reference. Operation 404 may be repeated, as necessary, for variables that appear in the source code. As discussed above, the state information service may be queried during an explain action (explained in detail below) in which an interpreter located in the run-time environment can query the state information service to determine if the variable exists, and if so, whether it is in scope to how it is referenced in the user generated code.

In an operation 406, state information: may be obtained based on the query.

In an operation 408, a determination of whether a variable exists and/or is in scope may be determined.

In an operation 410, responsive to a determination that the variable exists and is in scope, the source code may be transmitted to the run-time environment for implementation on the cloud service.

In an operation 412, responsive to a determination that the variable does not exist or is not in scope, a compile error may occur and be communicated.

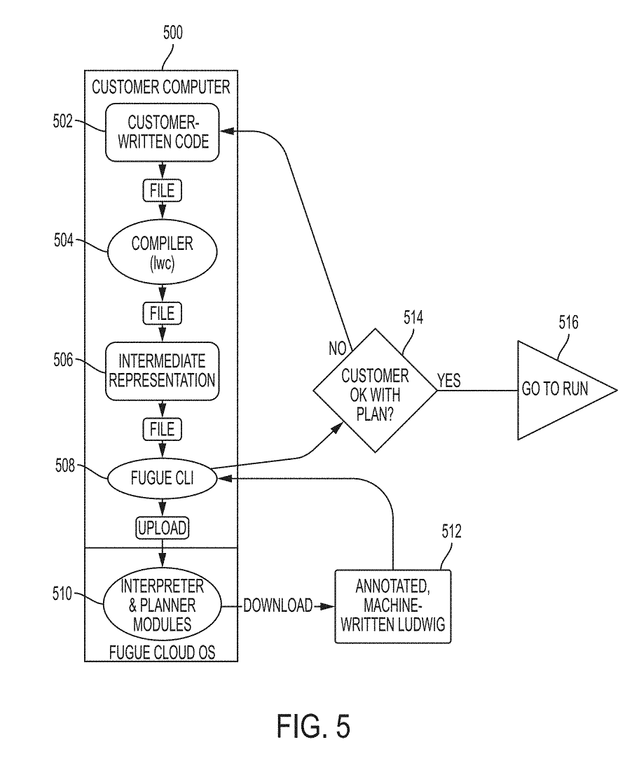

FIG. 5 illustrates an exemplary explain process according to examples of the disclosure. In the explain action illustrated in FIG. 5, steps 502, 504, 506, 508, and 510 operate in substantially the same way as their counterparts in FIG. 3 (i.e., steps 302, 304, 306, 308, and 310 respectively). However, in contrast to the process illustrated in FIG. 3, rather than converting the resource table generated by the interpreter into a machine instruction file, instead at step 512 the process returns the annotated resource table to the infrastructure operating system CLI 508.

As discussed above, as part of its operation, the interpreter can input the user declared instances of computing infrastructure, and query a state information service database to determine if they exist. If it is determined that the instance of computing infrastructure does not exist, then the state information service can indicate to the interpreter that the declared instance does not exist and the use can be notified at step 512.

If however all the declared variables exist, the user can be presented with a plan for how the infrastructure is to be implemented at step 514. At step 514 the user can determine if the received implementation plan is acceptable, and if so, the process can move to step 516 wherein the annotated coded produced at step 512 is converted into machine code that is compatible with the command line interface of a cloud computing services provider.

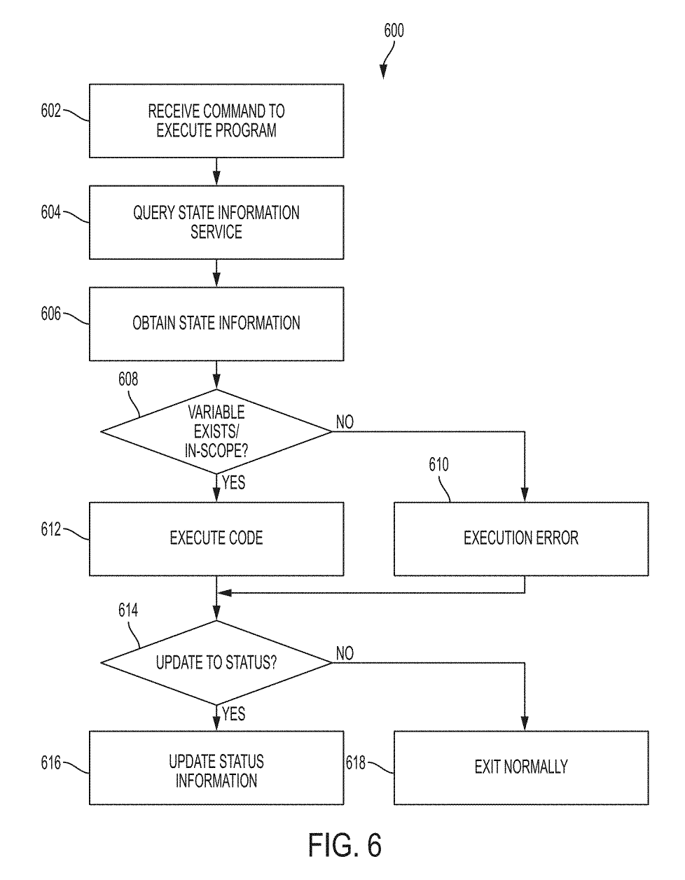

FIG. 6 illustrates a process 600 of executing a domain-specific programming language for cloud services infrastructure, according to an implementation of the invention. The various processing operations and/or data flows depicted in FIG. 6 are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 602, a command to execute a program compiled from source code using the domain-specific programming language may be received.

In an operation 604, a state information service may be queried to identify a variable in scope to the use in the language in order to determine if it exists, and, if so, whether it is in scope to reference. Operation 604 may be repeated, as necessary, for variables that appear in the source code.

In an operation 606, state information may be obtained based on the query.

In an operation 608, a determination of whether a variable exists and/or is in scope may be determined.

In an operation 610, responsive to a determination that the variable does not exist or is not in scope, a runtime error may occur and be communicated.

In an operation 612, responsive to a determination that the variable exists and is in scope, the program may be executed. Operation 612 may be repeated until all variables have been processed. In some implementations, execution of the code may cause a compute instance at a cloud service provider to be instantiated. In these implementations, state information (e.g., IP address, version, how used, etc.) may be stored via a state information service. In this manner, other programs that use the same variable may access the state information for the instantiated compute instance.

In an operation 614, a determination of whether an update to state information of an entity associated with a variable occurred during execution of the program may be made. For example, a program that uses a variable corresponding to a compute instance may have changed an IP address associated with the compute instance. Operation 614 may be repeated until all variables have been processed.

Responsive to a determination that an update occurred, in an operation 416, the state information may be updated via a state information service.

In an operation 618, code execution may terminate normally (e.g., without error conditions).

The domain-specific language described above can use one or more libraries to aid in the development of software. A library can include a collection of resources used by computer programs (such as those written in a domain-specific language) to allow for the development of software using the domain-specific language. Libraries can include configuration data, documentation, help data, message templates, pre-written code, subroutines, classes, values, type specifications.

Library code can be organized in such a way that it can be used by multiple programs that have no connection to one another. In other words, even if multiple users generate different programs using a coding language, by invoking a common library, each individual user-generated can use sub-routines and sub-programs that are contained within the library.

Therefore, in one example, a cloud computing infrastructure type can be invoked by a user-generated program, but the definition of that type can be stored in a library, so that any program which instantiates the type can use the code contained with the library to define the type.

The utility of libraries in a programming language can be utilized to enforce system policies on user-generated code developed in the domain-specific language. In one example, if a business or other enterprise wishes to ensure that computing infrastructure built on a cloud by the use of a domain-specific language complies with one or more policies of the enterprise with respect to computing infrastructure, they may utilize a validations library that when invoked will check the user-generated code to ensure that it complies with the desired policies. If the code does comply with the policies, then the code is allowed to compile and the computing infrastructure is built using the user-generated code. On the other hand, if the user-generated code does not comply with the enterprise's policies, the compiling of the code can be prevented and the user can be notified of the reason why the code was not allowed to be compiled.

In this way, the enterprise is able to allow for multiple individuals to build and maintain the enterprise's computing infrastructure via the cloud service provider, while at the same time ensuring that each and every instance of computing infrastructure built on behalf of the enterprise complies with the enterprise's self-defined policies.

A domain-specific language (and, by extension, a cloud operating system) can have the ability to add assertions to code that cause a compiler failure when the code it's related to does not meet its standards. That feature of the language can be known as Validations.

An administrator of the domain-specific language can write Validations and attach them to the Types affected with the keyword “validate,” in one example. Once the Types within the domain-specific language are attached, every time code written in the domain-specific language is compiled, it can check the user-generated code against the validations. This can happen locally on a domain-specific programming language author's desktop or on the cloud operating system, where validations are enforced against running infrastructure.

To illustrate the method of validation described above, an example is provided below. In the example, an enterprise wishes to enforce a policy wherein they desire to construct T types that only have the string “test” within them. Thus, when a user generates T types in the following manner:

type T:

| T {value: String}

The code will only be compiled if the string value contains the string “test” within it. In order to enforce this policy, a Validation library can be employed wherein the validations are laid out within the library. For example, the code below can be an example module to write to the Validations Library that can be used to enforce the policy described above.

import Ludwig.Validation as .
check-t: fun(t):

if String.equal(t.T.value, “test”) then

success

else

failure(“chedk-t failed”)

Wherein “Ludwig” can be a generic name for the domain-specific language, and wherein the function check-t can be the function within the Validations library that checks instantiations of the type T to determine if the policy of having them constructed only with the string “test” in them is followed.

The Validations library can then “register” the validations using the validate keyword: validate check-t. Once the validation has been registered, every time a T is constructed, the check-t validation function will be used to ensure that the instantiation of T contains the string “test” within it.

Another example is provided below. In the example below, the system administrator wishes to enforce a specific policy regarding the use of a type called “Apple.” First, the system administrator can create a Validation for the type “Apple” using the following code:

import Fugue.System.Apple as Apple
import Ludwig.Validation as Validation
fun noProcessesInTheFugueAccount(rule: Apple.Rule) −> Validation:

case rule.(Apple.Rule).action of

| Apple.AccountAction action −>

if action == Apple.AccountRunProcess then

let msg: “The AccountRunProcess permission is not
allowed in the fugue account.”
case rule.(Apple.Rule).subject of

| Apple.AccountType account −> case account of

| Apple.AllAccounts −>
Validation.failure(msg)

| Apple.Account acct −> if

acct.accountId == “fugue-12345678” then

Validation.failure(msg)

else

Validation.success

| _ −> Validation.success

else Validation.success

| | |
|---|---|
| \| _ | −> Validation.success |

validate noProcessesInTheFugueAccount

In the above code, the system administrator can import a library called Fugue.System.Apple by inserting the line of code which reads as “import Fugue.System.Apple as Apple” which can include the definitions of the type Apple. The system administrator can also import the validations library by inserting the line of code which reads as “import Ludwig.Validation as Validation.” Then the system administrator can proceed to define the validation function for type “Apple” by defining a function called “noProcessesInTheFugueAccount” as shown above. Finally, the system can register the validation provided above to the type “Apple” by inserting the line of code which reads as “validate noProcessesInTheFugueAccount.”

Once the validation for the type “Apple” has been created by the system administrator, a user can use that validation to validate their own instantiations of the type Apple when generating their own code. An example of a user using the Apple validation is shown below:

import Fugue.System.Apple as Apple
import NoProcessesInFugueAccount
user1: Apple.User {userId: “user1”}
fugueAccount: Apple.Account {accountId: “fugue-12345678”}
devAccount: Apple.Account {accountId: “dev-12345678”}
runProcessRule: Apple.accountRules {

principals: [user1],
accounts: [

fugueAccount,
devAccount,

],
actions: Apple.allAccountActions,

}

In the example above, the user can import the library called Fugue.System.Apple by inserting the line of code which reads as “import Fugue.System.Apple as Apple” which can include the definitions of the type Apple. The system administrator can also import the NoProcceseslnFugue library created by the system administrator as described above by inserting the line of code which reads as “import NoProcessesInFugueAccount.” Once the appropriate libraries have been imported the user can define their own code as shown in the example above.

The validations (as defined by the system administrator) on the type Apple can be run by using the compiler normally. In this example below, the compiler can be run from the user's laptop or desktop (i.e., the client machine).

$ lwc Apple.lw
ludwig (evaluation error):

“/opt/fugue/lib/Fugue/System/Apple.lw” (line 81, column 39):
error:

81| L.map(fun(t): case t of (p, a) −> Rule{principal: p, subject: AccountType(account),

action: AccountAction(a) }, L.cartesian-product(principals, actions))
\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }

Failed validations:

- The AccountRunProcess permission is not allowed in the fugue account. (from

NoProcessesInFugueAccount.noProcessesInTheFugueAccount)

Stack trace:

In call to f at “/opt/fugue/lib/Ludwig/List.lw” (line 133, column 32)
In call to map at “/opt/fugue/lib/Fugue/System/Apple.lw” (line 81, column 5)
In call to singleAccountRules at “/opt/fugue/lib/Fugue/System/Apple.lw” (line 77, column

38)

In call to f at “/opt/fugue/lib/Ludwig/List.lw” (line 133, column 32)
In call to map at “/opt/fugue/lib/Fugue/System/Apple.lw” (line 77, column 24)
In call to accountRules at “Apple.lw” (line 9, column 17)

In this way, if the user's use of the type Apple is in compliance with the policy set by the system administrator in the validations library for the type Apple, then the user-generated code can compile normally. On the other hand, if the user' use of the of the type Apple is not in compliance with the policy set by the system administrator in the validations library for the type Apple, then the user-generated code may fail to compile, and the user will be notified of the compilation error.

The compiler described above, in addition to determining whether the variable declared in the domain-specific language code exists and is within scope and validating the code or as a stand-alone feature, can be used in conjunction with a graphical user interface (GUI) be configured to provide the developer (i.e., the user developing the domain-specific language code) with a visualization of the computing environment that they are building using the domain-specific programming language.

Such a feature can enable a programmer to “see” the computing structure they are building out using the domain-specific programming language code, allowing for the programmer to modify the code so as to eventually generate their desired computing infrastructure on the cloud using a cloud service provider.

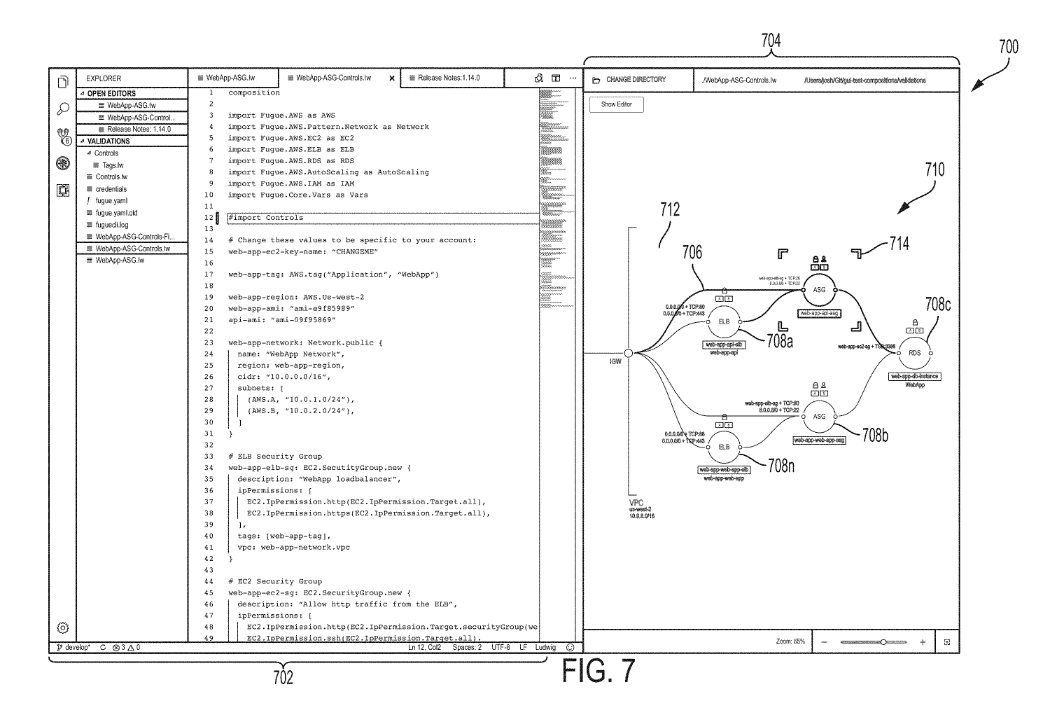

FIG. 7 illustrates an exemplary visualization of computing infrastructure created by domain-specific programming language code according to examples of the disclosure. The visualization 700 can include a text editing section 702 that displays a user's domain-specific programming language code, and can serve as a graphical user interface that allows a user to generate and edit their domain-specific programming language code. The text editing section 702 that is provided as part of the visualization 700 can be optional and a user alternatively can generate and modify their code using an external text editor of their choice.

The visualization 700 can also include a system diagram section 704. The system diagram section 704 can include a graphical representation of the computing infrastructure that has been declared on the domain-specific programming language code file being used to generate the graphical representation. In the example of FIG. 7, the system diagram section 704 can include a block diagram 710 of the computing infrastructure as declared within the domain specific programming language code illustrated in text editing section 702 of the visualization 700.

The block diagram 710 included within system diagram section 704 can include various shapes and text, all of which is provided to aid a user in gaining a visual understanding of the code they are generating using the domain-specific programming language. As an example, the block diagram can include one or more nodes 708a-c (depicted as circles). Nodes can represent various instances of computing infrastructure as declared within the domain-specific programming language code. For instance, within the domain-specific language code, a user can specify instances of computing infrastructure such as a load balancer, server, firewall, etc. In the block diagram 710 displayed in system diagram section 704 of visualization 700, the nodes 708a-c can labeled according to the type of computing instance it is meant to represent. For example, node 708a can represent an elastic load balancer, node 708b can represent an auto-scaling group, and node 708c can represent a relational database, as known to those of skill in the art. Each of the nodes 708a-c can appear in the block diagram 710 based on those nodes having been declared in the domain-specific programming language code illustrated within text editing section 702.

The block diagram 710 can also include a one or more connectors 706. Connectors 706 can represent various communications pathways between various nodes of the block diagram. The block diagram 710 can also include an indication of groups 712. In the example of FIG. 7, groups 712 are indicated by a bracket. Groups 712 can represent a collection of nodes for example within an virtual private cloud (VPC). In the example of FIG. 7, groups 712 can represent the collection of nodes 708a-c.

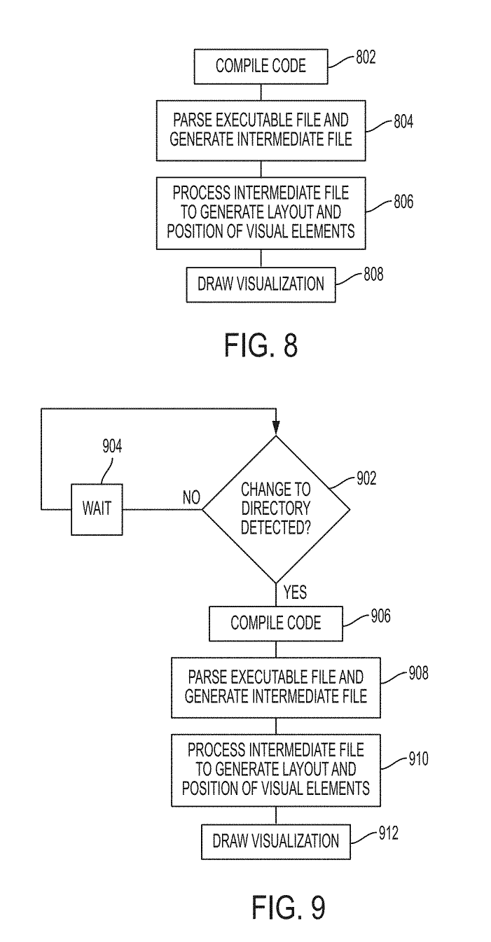

A method for generating a visualization can include a process that converts domain-specific language code into the elements of the block diagram as discussed above. FIG. 8 illustrates an exemplary method for generating a visualization of computing infrastructure using domain-specific programming language code according to examples of the disclosure. The method 800 can describe the process by which code written in a domain-specific language can be converted into a visual representation of the computing infrastructure declared within the code.

The method 800 can begin at step 802, wherein code written in a domain-specific programming language can be compiled using a compiler, similar to the examples discussed above. Thus, like the examples discussed above, the code can be checked against a state information service to determine whether each and every variable declared in the code exists and is within scope. Also as discussed above, through the compilation process, the code can be validated against one or more computing policies of an organization or enterprise.

The output of the compilation, as also described above, can be an executable program that can later be used to generate one or more commands to a command line interface of a cloud service provider so as to build the desired computing infrastructure on a cloud account. In one or more examples, rather than producing an executable file, the compiler can produce a data file that can be read by a cloud operating system. Throughout the specification, the term executable program, data file, and executable file are interchangeably used. In one example, the data file can take the form of a JavaScript Object Notation (JSON) file that can represent what was contained in the domain-specific programming language code file and can be used to generate the visualization of the computing infrastructure declared in the code. In some examples, the compiler can be changeably configured and can include one or more options that can be selected by a user. For example, if the output of the compiler is to be used specifically for visualization purposes, a setting on compiler can be adjusted to ensure that any compilation error messages are descriptive enough, so that when visualized can, in greater detail, inform the programmer as to the nature of the compilation error. In another example, the compiler can be configured to output JSON files and in other embodiments can be configured to output other file formats based on the needs of the interface that will be utilizing the data file.

After compiling the code and generating a data file at step 802, the process 800 can move to step 804, wherein the generated executable file is parsed and is converted into an intermediate file format that contains a data structure that can be better suited to create the visual representation. In order to eventually draw a graphical representation of the computing environment based on a domain-specific language program code, in some examples, the executable code can be converted into a custom data structure that can be used by the process 800 to generate the graphical representation.

The process of converting the data file into the custom data structure can include parsing the data file so as to search for specific features contained within the data file, and if the specific feature is found, to generate code in the custom data structure corresponding to the feature in the data file. For example, the code can be parsed to search for declarations of computing infrastructure (i.e., load balancers, firewalls, servers, etc.) When the parsing encounters an instance of computing infrastructure, a declaration of “circle” can be written in the intermediate file to denote a circle. Thus, during the parsing of the data file, if an instance of a computing infrastructure is encountered, the intermediate file can be written to so as to describe the instance of computing infrastructure (i.e., whether it is a load balancer, database, server, etc.) and what shape the instance will appear on the visual representation (i.e., a circle.)

As part of the customized data structure, in one example of the disclosure, each node (i.e., circle) can also have a tag associated with it. A “tag” can refer a set of attributes associated with the node such as a security group or any other various features of the node. Thus, according to examples of the disclosure, the customized data structure can include a declaration of the node found in the parsed data file, the shape associated with the node, and any tags (i.e., attributes) associated with the node, such as type, security group etc.

The parsing can also search for “edges” between computing instances in the executable file, wherein edges can refer to communication pathways between various nodes in the computing infrastructure. When an edge is encountered in the data file, the intermediate file can note the occurrence of the edge and also assign a shape to the edge. In one example, edges can be denoted by lines. Thus the custom data structure within the intermediate file can denote the edge, what nodes the edge connects, and can also indicate that the edge is to be denoted by a line when the visual representation of the computing infrastructure is rendered. In another example, the parsing can also search for groups. As discussed above, groups can indicate a collection of nodes, and can be stored in the intermediate file using the custom data structure as brackets.

Once the code has been parsed and the intermediate file has been generated using the custom data structure as described above, the process 800 can move to step 806 wherein the intermediate file generated in step 804 can be processed so as to generate a layout and position of each visual element identified in the intermediate file. The intermediate file, as described above, simply contains the elements that are to visually rendered, and various attributes associated with the elements. In order to create visually render the elements, the process 800 can determine at step 806 the physical position of each element. In one example, the process 800 at step 806 can determine the (x,y) coordinate of each element within the system diagram section 704 (as described with respect to FIG. 7). At step 806, the process can run the intermediate file through a library that attempts to lay the elements listed in the intermediate file in a graph diagram and assign x and y coordinates to all of the nodes, and connects nodes using lines based on the edges determined in step 804.

In one example, the layout of the elements can be based on the number of connections (i.e., edges) between various nodes. In other words, if an edge is required to be drawn between a set of nodes, then that fact can be used to determine where each node and the line or lines connecting each node should laid out (in x and y space). At step 806, the intermediate file can be amended such that each node is assigned a specific (x,y) coordinate in the system diagram section 704. In order to assign an (x,y) coordinate to each element listed in the intermediate file, the process 800 at step 806 can employ, in one example, a directed graph rendering library. The directed graph library can assign (x,y) coordinates to each element (i.e., node) based on the existence of and the number of connections between each node, and can assign (x,y) coordinates to each node such that so as to avoid having any connections intersect, or having any of the connections going through an individual element listed in the intermediate file.

At the output of step 806, the intermediate file can now include a listing of all elements (i.e., nodes), their associated attributes, any connection information between the nodes, and an assigned (x,y) position for each node. Once the intermediate file has been modified to include the (x,y) coordinates of each element, as determined at step 806, the process 800 can move to step 808, wherein the visual representation of the computing infrastructure declared in the domain-specific programming language can be rendered. At step 808, the intermediate file can be ingested, i.e., used as an input, to render the visual representation of the computing infrastructure.

In one example, the intermediate file with (x,y) coordinates can be converted to hyper-text markup language (HTML) so as to visually render the computing infrastructure. In this example, the shapes (i.e., the circles) can be rendered using the HTML canvas element, and the text labels can be rendered using standard HTML. As is known in the art, HTML can allow for the drawing of images, pixel-by-pixel. The HTML code generated to render the visual representation of the computing infrastructure can include two layers. The first layer, i.e., the canvas layer can be used to draw the various shapes associated with the computing infrastructure as declared in the intermediate file, at a location commensurate with the (x,y) coordinates as determined at step 806. The second layer, can generate text in a location pre-determined in relation to the shapes, so as to identify the nodes and provide any information associated with each node.

In some examples, the visual representation of the computing infrastructure generated using HTML can be zoomed in and out by a user. The zooming process can be achieved through the use of a 3-D matrix transformation algorithm that can perform a transform on all the labels and visual elements to calculate and adjust their positioning based on the desired zooming level.

Referring back to step 802, wherein the domain-specific language code can be compiled. The compilation, in some examples, can be manually initiated by a user of the visualization process outlined in the example of FIG. 8. However, in other examples, the process can be initiated automatically.

FIG. 9 illustrates another exemplary method for generating a visualization of computing infrastructure using domain-specific programming language code according to examples of the disclosure. In the example of FIG. 9, the compilation step 906 can be initiated by detecting a change to a file in a selected directory in which the domain-specific program code of interest exists within a memory. Thus, at step 902, the process can determine if a change to the directory (i.e., a change to a file within the directory) has occurred. If no change is detected, the process can optionally move to step 904 wherein the process waits a pre-determined amount of time before returning to step 902 to check if a change has occurred. In another example, if no change is detected, the process can loop back to step 902 and keep looping back until a change is detected.

Once a change has been detected, the process can move to step 906 wherein the code is compiled. Steps 906, 908, 910, and 912 can be identical to steps 802, 804, 806, and 808 respectively, and thus a discussion of steps 906, 908, 910, and 912 can be found above with respect to the discussion of their counterparts in the example of FIG. 8.

Returning to the example of FIG. 8, as previously discussed at step 802, the domain-specific language code can be compiled. The rest of the process 800 can proceed so long as the compilation step performed at step 802 is successful thereby generating an data file as discussed above. However, in the event that the domain-specific language code has one or more errors contained within it such that the compiler is not able to compile the code and generate an data file, the process can go no further due to the absence of the data file. Thus, a visual representation of the domain-specific may not be generated due to the lack of an data file with which to build the visualization.

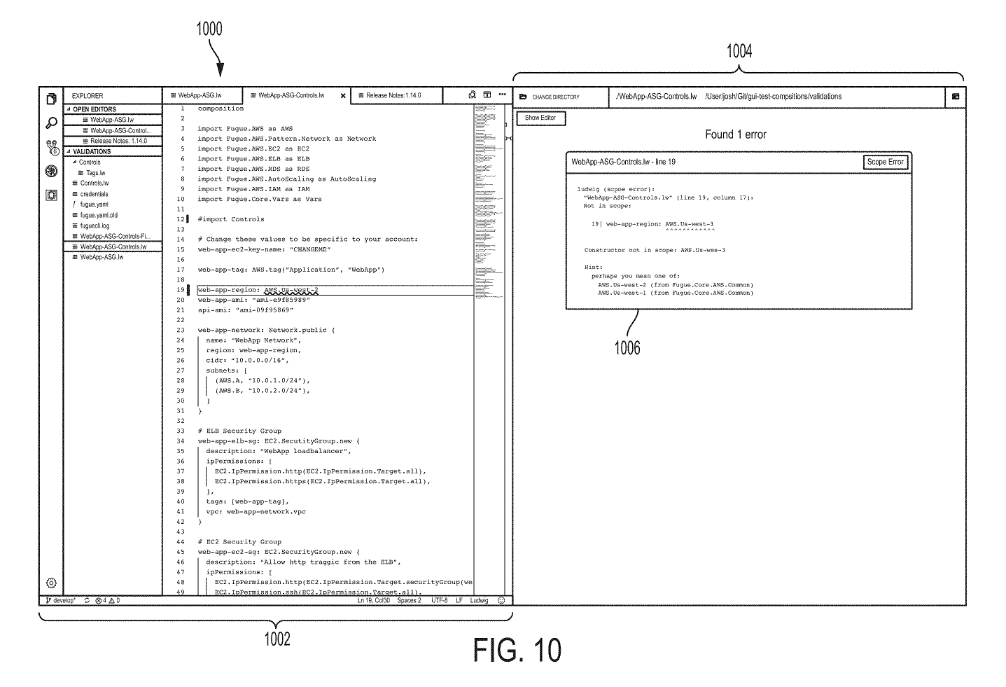

In the case that the domain-specific language code contains one or more errors, instead of rendering a visualization of the computing infrastructure declared within the domain-specific language, the user can receive and error message. FIG. 10 illustrates an exemplary compilation error message generated by a visualization tool according to examples of the disclosure. Similar to the example of FIG. 7, the visualization 1000 can include a text editing section 1002 that displays a user's domain-specific programming language code, and can serve as a graphical user interface that allows a user to generate and edit their domain-specific programming language code. The text editing section 1002 that is provided as part of the visualization 700 can be optional and a user alternatively can generate and modify their code using an external text editor of their choice. Also as in FIG. 7, the visualization 1000 can also include a system diagram section 1004. The system diagram section 1004 can include a graphical representation of the computing infrastructure that has been declared on the domain-specific programming language code file being used to generate the graphical representation. However, in the example of FIG. 10, the code cannot be compiled and thus no system diagram is able to be rendered in the system diagram section 1004. Instead, as shown in FIG. 10, the system diagram section 1004 instead contains an error message that notifies the developer that their code has one or more errors.

As discussed above, code generated in a domain-specific programming language can be validated during the compilation process. The validation process can ensure that the code written by a developer and the computing infrastructure engendered by the code is compliant with one or more policies of an organization or enterprise associated with the computing environment to be built or modified. As discussed above, even if a code file is found to violate various computing policies during the validation process, the file can still be compiled and an data file can be generated. The visualization process described above, can be used to alert a developer to the validation error.

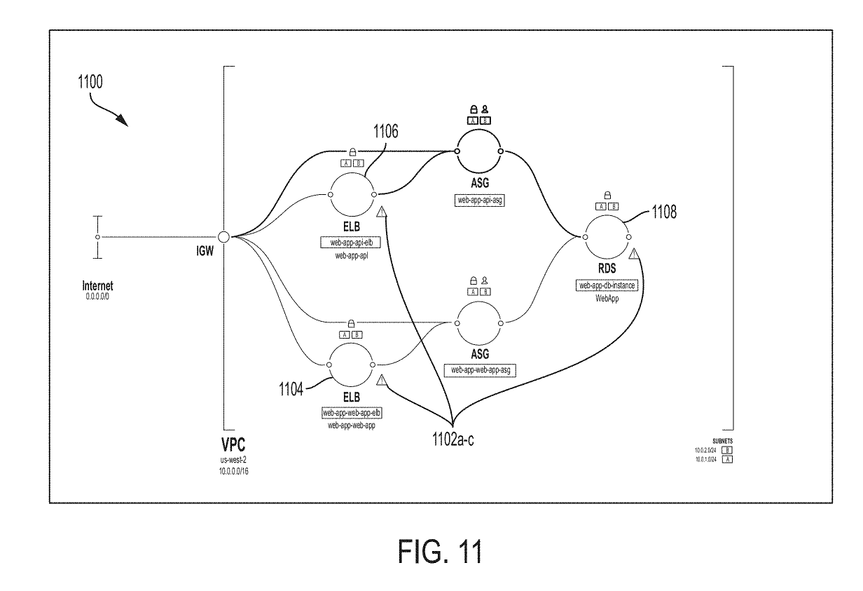

FIG. 11 illustrates an exemplary visualization of computing infrastructure using domain-specific programming language code that includes visualizations associated with validation errors according to examples of the disclosure. The example of FIG. 11 illustrates a system diagram that has been generated from a domain-specific programming language code that has a plurality of validation errors. Referring back to FIG. 8, when the data file is parsed at step 804 and is converted to the intermediate representation, the parsing process can also identify any validation errors that appear in the data file and can associate those validation errors with one or more nodes denoted in the intermediate representation and determined from the data file. Thus, in one example, the custom data structure within an intermediate file can include an indication of a node (for example a load balancer), the shape of the node (for example a circle), any attributes associated with the node (for example the security group of the node) and whether the node has any validation errors associated with it.

In the example of FIG. 11, the system diagram 110 can include nodes 1104, 1106, and 1108. If these particular nodes had a validation error associated with it, the visualization can indicate the validation error by placing a small triangle 1102a-c next to each node that has failed so as to indicate to a user that the particular node has a validation error associated with it. In other examples, a user can click on a particular node that has a validation error associated with it, and information can be displayed to the user that provides the details of the validation error.

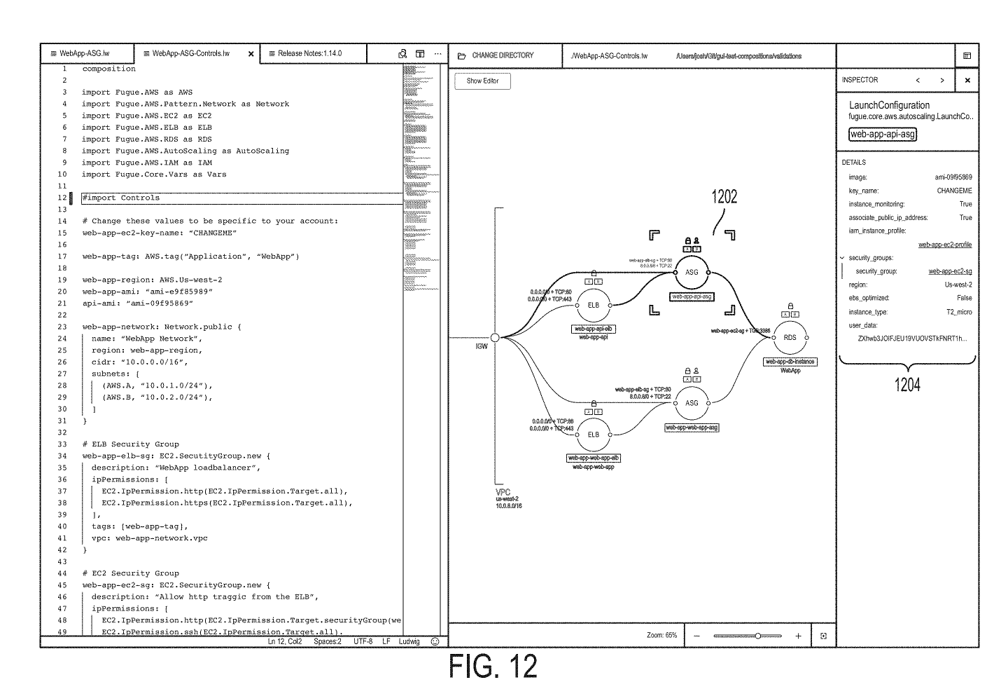

FIG. 12 illustrates an exemplary instance inspection in a visualization of domain-specific programming language code according to examples of the disclosure. The example of FIG. 12 can be identical to the example discussed with respect to FIG. 7. In the example of FIG. 12, a user can click on a node, causing the node to be highlighted as shown at 1202. When a user highlights a node, a separate window 1204 can be generated that provides information regarding the node such as the identity of the node, and attributes of the node (as discussed above) such as the security group of the node, and the ID of the node.

A user who creates a visualization of computing infrastructure to be built in a cloud computing environment may wish to share the generated visualization with third-parties such as co-developers or other members of their particular enterprise organization. The user in that instance can transmit the image file that contains the visualization to the third-party, and the user can view that image on any electronic device that is configured to display images using the file format that the user transmitted the image with. However, the receiver of the image may be limited as to what they can do with the image. For example, when the third-party receives the visualization, he or she may be able to see the image that is produced from the visualized code, but may not be able to see the underlying domain-specific language code that formed the basis of the shared visualization. In one or more examples, the user may wish to manipulate the code used to generate the received visualization so they can create a similar computing system for their own purposes.

In order to allow a third-party to see both the visualization and the domain-specific language code used to create the visualization, the user who created the program may need to separately transmit the image file and the code file to the third-party. Sending both files can be cumbersome and inconvenient, especially if both files are large in size and require a significant amount of bandwidth to transmit. Furthermore, the user wishing to transmit the image and/or code, may not know whether the third-party receiver user actually wants the underlying code that was used to generate the visualization, and thus sending both files may be an inefficient use of resources. However, if a user was able to send a single file that could be used for both for viewing the visualization and gaining access to the code used to generate the visualization, the process of sharing developed computing system architectures that are rendered in a cloud computing environment could be simplified.

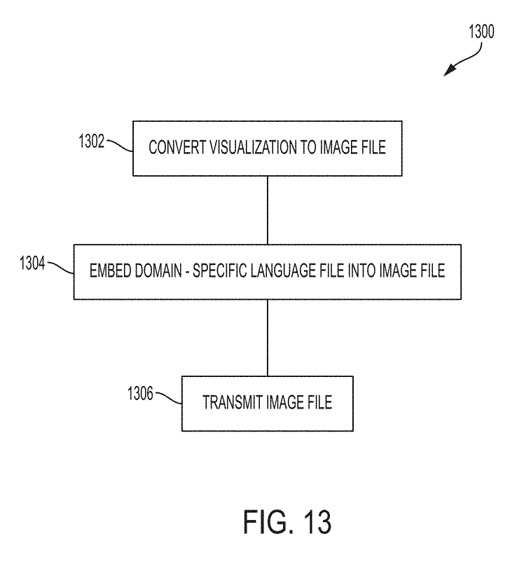

FIG. 13 illustrates an exemplary method for embedding domain-specific language code within a visualization of computing infrastructure according to examples of the disclosure. The process 1300 can begin with step 1302, wherein a visualization (generated by the processes described above, or generated by alternative methods) is converted into an image file. As discussed above, visualizations of computing infrastructure, in one example, can be rendered using an html file. Thus at process 1302, generating the visualization image file can simply mean generating a copy of the html file generated per the processes described above to create the visualization. In one or more examples of the disclosure, generating the visualization image file can include generating an image file in another format. As an example, an image file can be created using the Scalable Vector Graphics (SVG) format. The SVG format is a markup language based vector image format for two-dimensional graphics. In one or more examples, the html file used to render the visualization can be converted into an SVG file at step 1302, or alternatively, the visualization itself can be used to generate the SVG file.

Once the visualization image file has been generated at step 1302, the process can move to step 1304 wherein the domain-specific language code used to generate the visualization can be embedded within the visualization image file generated at step 1302. In one or more examples, the domain-specific language code can be embedded within the image file in a manner such that the code can only be extracted by a computer program that has a priori knowledge of how the code is embedded in the image file, and how that code is to be extracted. Also, the code can be embedded in a manner such that it does not interfere with visualization of the image file by a program that may not have use for the embedded code.

As an example, the domain-specific language program that was used to generate the visualization can be embedded into the visualization image file by placing comment tags with a distinguishable characteristic around each line of code. The use of a comment tag can ensure that the embedded code is not read by a graphics program that would then try to graphically render the lines of code. Using a comment tag with a distinguishing characteristic can ensure that the program used to extract the embedded code is able to distinguish between lines of the embedded code and other general comments that may be present in the visualization image file. As an example, a conventional comment tag in SVG can appear as follows:
<!--“comment”-->

A program that is configured to render images out of SVG files can know that any text that appears between the “<!-” symbol and the “-->” symbol is to be ignored with rendering an image from the file. Code that is embedded within the image program can take advantage of the comment tag feature to ensure that the code doesn't not cause an error when rendering the visualization contained within the image file.

However, using the comment tags in and of themselves to embed code within the visualization file may not be sufficient. A program that can be used to extract the code embedded within a visualization image file may not be able to distinguish between a general comment, and a line of code in the domain-specific programming language. Thus, using one or more distinguishing characters within the comment can help to distinguish a line of domain-specific language code from a general comment embedded in the visualization image file. As an example the following distinguishable comment could be employed:
<!--%$# “line of code”-->

In the above example, the comment could employ the same standard comment tag as discussed above (i.e., <!--) but can also use the first three characters appearing after the comment tag marker to identify the comment as a line of code from the domain-specific programming language code. In the above example, the characters “%$#” can appear as the first three characters after the comment tag to denote a line of code. In this way, the lines of code embedded within the visualization image file can be distinguished from general comments. The example below can illustrate this feature:
<!--%$# “line 1”-->
<!--“line 2”-->
<!--%$# “line 3”-->
<!--%$# “line 4”-->
<!--“line 5”-->

In the above example, lines 1, 3, and 4 can be recognized as lines of code from the domain-specific language program embedded within the visualization image file, whereas lines 2 and 5 can be identified as general comments.

Thus at step 1304, the process of embedding code into visualization program can include writing each line of the code into the visualization image file by applying a comment tag with distinguishing characteristics to each line of code and then writing the lines into the visualization image file. In another example, the domain-specific programming language code can be embedded in the visualization image file by placing it into a known location within an image. For instance, if the visualization image file was implement using a bitmap graphics format, the code could be embedded in a grid of 24 bit pixels at a known location within the image. Each pixel in the bitmap image can contain 3 unicode characters. The domain-specific programming language could then be embedded into the visualization image file by placing the data into each pixel of the known location within the bitmap image in a manner so that the human eye may not be able to perceive the presence of the data when the visualization is rendered, but nonetheless can be located by a program that can extract the code from the visualization image file.

In addition to embedding a user-generated domain-specific programming language code within a visualization image file, the process 1300 at step 1304 can also embed any dependencies (i.e., library files) that are referenced within the domain-specific programming language code. In one example, the entire library file associated with a dependency within a domain-specific language program can be embedded into the visualization image file in a manner described above. In another example, only the specific portions of the library files that are referenced by the domain-specific programming language can be embedded into the visualization image file.

Once the visualization image file has been generated with the domain-specific programming language code and dependencies embedded within the file, the process can move to step 1306 wherein the visualization image file is transmitted to a third-party. By generating a file that can be used both for visualizing the computing infrastructure and viewing the code associated with the visualization, the third-party recipient of the file can choose to either simply visualize the infrastructure, inspect its underlying code, or both.

As discussed above, the receiver of the file generated by the process described with respect to FIG. 13 can either view the visualization of the computing infrastructure, view the domain-specific programming language code associated with the visualized computing infrastructure or both. If the user simply wants to the view the image, then any image viewing program that has the ability to read files in the format of the transmitted visualization image file (e.g., SVG, JPG, bitmap, etc.) can be employed. However, if the receiver of the transmitted file wants to view the domain-specific programming language code used to generate the visualization, then the receiver may need to utilize a program that is configured to extract the code embedded in the visualization file.

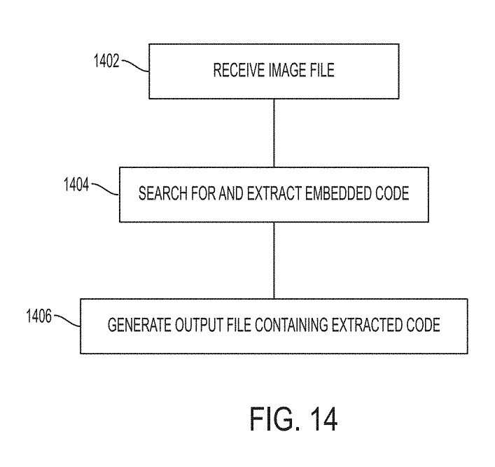

FIG. 14 illustrates an exemplary process for extracting domain-specific programming language code embedded within a visualization image file according to examples of the disclosure. The process 1400 can begin at step 1402 wherein a visualization image file (generated, for example, by the process described with respect to FIG. 13) is received. In one or more examples, the visualization image file can be transmitted via email, text message, Bluetooth, Near-Field Communication (NFC), etc. Once the file has been received at step 1402, the process 1400 can move to step 1404 wherein the received visualization image file can be opened, parsed, and searched for any domain-specific language code embedded within the file.

As discussed above with respect to step 1304 of FIG. 13, in one or more examples, the domain-specific language code associated with a computing infrastructure visualization can be embedded within an image file by inserting the code using comment tags that have distinguishing characteristics. At step 1404, in order to extract code embedded using comment tags with distinguishing characteristics, in or more examples the receiving program can parse the received file and search for any comment tags that also contain the distinguishing features. Using the example provided above, the receiving program can search for comment tags that begin with “<!--%$#.” As discussed above, “<!--” can indicate a comment tag in the SVG file format, and “%$#” can be an arbitrary string of characters that can be used to distinguish a standard comment tag from a comment tag that includes domain-specific programming language code.

At step 1404, once the program identifies a comment tag that contains domain-specific programming language code embedded it, the program can make a copy of the contents of the comment tag (minus the distinguishing characters) and write them to a separate file. The program can parse the visualization image file line-by-line, identifying and copying embedded domain-specific programming language code into a separate file, until the entire received visualization image file is parsed. Once every line of the visualization image file has been parsed, the process 1400 can move to step 1406 wherein the output file containing the extracted code is finalized and made available to a user of the receiving program.

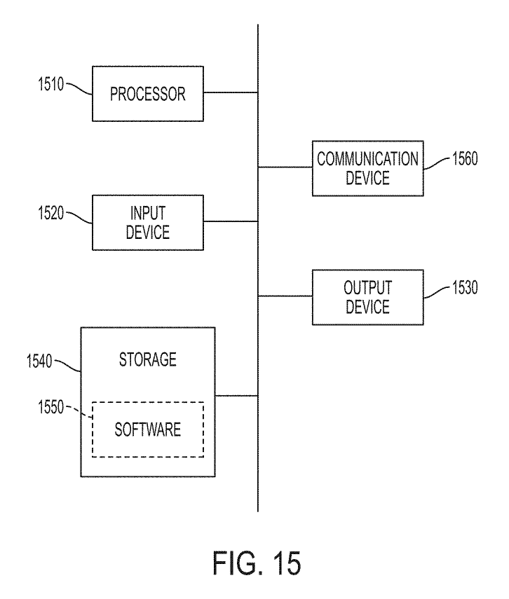

FIG. 15 illustrates an example of a computing device in accordance with one embodiment. Device 1500 can be a host computer connected to a network. Device 1500 can be a client computer or a server. As shown in FIG. 15, device 1500 can be any suitable type of microprocessor-based device, such as a personal computer, workstation, server or handheld computing device (portable electronic device) such as a phone or tablet. The device can include, for example, one or more of processor 1510, input device 1520, output device 1530, storage 1540, and communication device 1560. Input device 1520 and output device 1530 can generally correspond to those described above, and can either be connectable or integrated with the computer.

Input device 1520 can be any suitable device that provides input, such as a touch screen, keyboard or keypad, mouse, or voice-recognition device. Output device 1530 can be any suitable device that provides output, such as a touch screen, haptics device, or speaker.

Storage 1540 can be any suitable device that provides storage, such as an electrical, magnetic or optical memory including a RAM, cache, hard drive, or removable storage disk. Communication device 1560 can include any suitable device capable of transmitting and receiving signals over a network, such as a network interface chip or device. The components of the computer can be connected in any suitable manner, such as via a physical bus or wirelessly.

Software 1550, which can be stored in storage 1540 and executed by processor 1510, can include, for example, the programming that embodies the functionality of the present disclosure (e.g., as embodied in the devices as described above).

Software 1550 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1540, that can contain or store programming for use by or in connection with an instruction execution system, apparatus, or device.

Software 1550 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

Device 1500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 1500 can implement any operating system suitable for operating on the network. Software 1550 can be written in any suitable programming language, such as C, C++, Java or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

What is claimed is:

1. A method for embedding a domain-specific programming language file within an image file associated with a computing system, the method comprising:
generating a image file based on a visualization of the computing system, wherein the visualization of the computing system is based on a domain-specific language representation of the computing system;
embedding the domain-specific programming language file within the generated image file;
transmitting the generated visualization image with the embedded code.

2. The method of claim 1, wherein the domain-specific programming language file includes a plurality of lines of code, and wherein embedding the domain-specific programming language file within the generated image file includes writing each line of the domain-specific programming language file into the image file.

3. The method of claim 2, wherein writing each line of the domain-specific programming language file into the image file includes writing a comment tag into the image file, appending one or more distinguishing characters after the comment tag, and appending a line of code of the plurality of lines of code after the appending distinguishing characters and the comment tag into the image file.

4. The method of claim 1, wherein the image file is in the Scalable Vector Graphics (SVG) format.

5. The method of claim 1, wherein the image file is in the Hyper Text Markup Language (HTML) format.

6. The method of claim 1, the method comprising:
generating a visualization of the computing system from the domain-specific programming language file.

7. The method of claim 6, wherein generating the visualization comprises:
compiling the domain-specific programming file to generate a data file, wherein the generated data file is based on the domain-specific programming language file;
generating an intermediate file based on the data file, wherein generating the intermediate file comprises:
parsing the data file to determine the presence of one or more elements contained within the data file;
for each element found within the data file, associating a shape with the element, and associating one or more attributes with the element;
determining one or more connections between elements of the one or more elements; and
writing each element, the shape associated with each element, the one or more attributes associated with each element, and the determined one or more connections between elements to the intermediate file;
determining a position for each element of the one or more elements, and writing the determined position for each element to the intermediate file; and
graphically rendering a diagram of the computing system based on the intermediate file.

8. The method of claim 7, wherein compiling the domain-specific programming file to generate an data file includes querying a state information service to determine whether one or more variables contained within the domain-specific programming file exist within the state information service and are within a scope specified by the state information service.

9. The method of claim 7, wherein determining a position for each element of the one or more elements includes associating an (x,y) position for each element of the one or more elements.

10. The method of claim 7, wherein determining a position for each element of the one or more elements includes utilizing a directed graph library to associate an (x,y) position for each element of the one or more elements.

11. The method of claim 7, wherein the one or more attributes associated with each element can include a security group associated with each element.

12. The method of claim 7, wherein the data file is implemented using JavaScript Object Notation (JSON).

13. The method of claim 7, wherein determining a positing for each element of the one or more elements can be based on a determined number of connections associated with the element.

14. The method of claim 7, wherein graphically rendering a diagram of the computing system based on the intermediate file can include rendering the diagram using hyper text markup language (HTML) code.

15. The method of claim 14, wherein the one or more elements can be graphically rendered using a canvas element of the HTML code.

16. The method of claim 7, wherein the method further comprises associating one or more validation errors with the one or more elements.

17. The method of claim 16, wherein the method further comprises graphically rendering a visual indicator of the one or more validations errors proximally to a graphical representation of the one or more elements to which the one or more validations errors are associated with.

18. A method for extracting a domain-specific programming language file from an image file, the method comprising:
receiving an image file;
searching the received image file to determine the presence of one or more lines of domain-specific language programming code embedded within the received image file;
creating a domain-specific programming language file; and
for each line of domain-specific language programming code found within the received image, writing the line of code in the generated domain-specific programming language file.

19. The method of claim 18, wherein the received image file includes a plurality of lines of code, and wherein searching the image file includes searching for one or more lines of domain-specific programming language code embedded within the image file.

20. The method of claim 19, wherein searching the image file for one or more lines of domain-specific programming language code embedded within the image file includes searching for one more comment tags contained within the image file.

21. The method of claim 20, wherein searching the image file includes searching for one or more distinguishing characters for each comment tag found in the image file.

22. The method of claim 18, wherein the image file is in the Scalable Vector Graphics (SVG) format.

23. The method of claim 18, wherein the image file is in the Hyper Text Markup Language (HTML) format.
